(19) United States
(12) Patent Application Publication
(10) Pub. No.: US 2023/0364886 A1
(43) Pub. Date: Nov. 16, 2023

(54) LIGHTLY MODIFIED BAMBOO COMPOSITE SYSTEMS

(71) Applicant: VIRGINIA TECH INTELLECTUAL PROPERTIES, INC., Blacksburg, VA (US)

(72) Inventors: Jonas Hauptman, Blacksburg, VA (US); Daniel Hindman, Blacksburg, VA (US)

(21) Appl. No.: 18/196,874

(22) Filed: May 12, 2023

Related U.S. Application Data
(60) Provisional application No. 63/341,120, filed on May 12, 2022.

(51) Int. Cl. B32B 9/02; B27J 1/00; B32B 5/02; B32B 3/20; B32B 9/04; B32B 7/12; B32B 7/08; B32B 37/12; B32B 37/16

(52) U.S. Cl. CPC B32B 9/02; B27J 1/003; B32B 5/024; B32B 3/20; B32B 9/047; B32B 7/12; B32B 7/08; B32B 37/12; B32B 37/16; B32B 2260/02; B32B 2260/04; B32B 2607/00; B32B 2317/18

(57) ABSTRACT

Various examples are provided related to panel systems fabricated from bamboo. In one example, a panel system includes a central core including a layer of substantially aligned bamboo poles; a first outer lath layer including substantially aligned bamboo lathes or poles extending across a first side of the central core; and a second outer lath layer including substantially aligned bamboo lathes or poles extending across a second side of the central core. The bamboo lathes or poles of the first outer lath layer can be at an angle with respect to the bamboo poles and the bamboo laths or poles of the second outer lath layer can positioned at the same or another angle with respect to the bamboo poles. In other examples, beams or other structural elements can be fabricated using one-way lamination of bamboo elements.

### CROSS REFERENCE TO RELATED APPLICATIONS

This application claims priority to, and the benefit of, co-pending U.S. provisional application entitled “Modified Bamboo Composite Systems” having Ser. No. 63/341,120, filed May 12, 2022, which is hereby incorporated by reference in its entirety.

### BACKGROUND

Bamboo systems hold great potential for human development in the global tropics where bamboo grows plentifully and is regenerative. The demand for contemporary high performing multi-story multi-family housing has already outstripped supply and is expected to grow by two billion people by 2050, mainly in urban areas, while the need to reduce carbon emissions in the atmosphere begs for solutions to displace the reliance on cement and steel in construction for carbon neutral or sequestering products.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates examples of tested bamboo panels orientation, in accordance with various embodiments of the present disclosure.

FIG. 2 illustrates an example of a multidirectional lightly modified bamboo composite panel construction, in accordance with various embodiments of the present disclosure.

FIGS. 3A-3C, 4A-4B and 5A-5B and 5D illustrate examples of mass bamboo cross laminated panels fabricated for mechanical testing, in accordance with various embodiments of the present disclosure.

FIG. 5C illustrates an example of a lightly modified and lightly framed bamboo panel fabricated for mechanical testing, in accordance with various embodiments of the present disclosure.

FIG. 5D illustrates another example of a mass bamboo panel, in accordance with various embodiments of the present disclosure.

FIG. 6A illustrates deflection test results of the cross laminated panels of FIGS. 3A-3C, 4A-4B and 5A-5C, in accordance with various embodiments of the present disclosure.

FIG. 6B is an image illustrating 3-point bend testing of the cross laminated panel of FIG. 5B, in accordance with various embodiments of the present disclosure.

FIGS. 7A and 7B are images illustrating an example of a splice culm to culm joint, in accordance with various embodiments of the present disclosure.

FIGS. 8A-8F are images illustrating examples of mass bamboo panel to panel splice and corner joining methods that can be used to assemble a structure with mass bamboo panels, in accordance with various embodiments of the present disclosure.

FIGS. 9A and 9B illustrate examples of a bamboo beam, in accordance with various embodiments of the present disclosure.

FIGS. 10A and 10B illustrate examples of BioMass bamboo composite structures, in accordance with various embodiments of the present disclosure.

FIG. 11 illustrates how a Mass Bamboo panel can be intelligently assembled in which different parts of the bamboo culm can be targeted for application in different parts a Mass Bamboo panel, in accordance with various embodiments of the present disclosure.

FIG. 12 is an image illustrating examples of analog and digitally modified bamboo, in accordance with various embodiments of the present disclosure.

FIGS. 13A and 13B illustrate an example of contextualizing bamboo solidities, in accordance with various embodiments of the present disclosure.

FIGS. 14A-14D illustrate examples of bamboo characteristics and grading, in accordance with various embodiments of the present disclosure.

FIGS. 15A-15C illustrate examples of equipment for bamboo processing and evaluation, in accordance with various embodiments of the present disclosure.

FIG. 16 illustrates an example of linearity variation in a bamboo element, in accordance with various embodiments of the present disclosure.

FIG. 17 illustrates an overview and evaluation of tools for facing bamboo, in accordance with various embodiments of the present disclosure.

FIG. 18 shows a modified radial arm saw capable of running a single blade or two parallel blades on one arbor and a fixturing jig used to support a bamboo culm in the process of creating flat faces on one or more sides, in accordance with various embodiments of the present disclosure.

FIG. 19 illustrates examples of digital (CNC cut) features that can be milled in the bamboo, in accordance with various embodiments of the present disclosure.

FIG. 20 includes images of an example of a 4th axis positioning jig, in accordance with various embodiments of the present disclosure.

### DETAILED DESCRIPTION

Disclosed herein are various examples related to panel systems fabricated from bamboo. A unitized manufacturing and panel system useful to construct buildings from lightly modified woody bamboo culms is disclosed. The panels can be fabricated in a manner that aggregating slightly (or lightly) modified culm bamboo with extremely low waste, offering improved strength and stiffness, and free of the need for excessive amounts of resins. Until now there have only been bamboo building products that utilize fully natural culm bamboo or others that totally disaggregate the morphological intelligence of bamboo a fast-growing grass capable of carrying structural loads as a building element. A series of methods to assemble and cross laminate bamboo are presented. Examples of these have been reduced to practice and mechanically tested with promising results. Multiple panel intra-element configurations have been developed that have been assembled via multiple methods including chemical (adhesive), mechanical stapling, screwing and bolting and even via growing composite action through mycelium-bamboo hybrid panels. A unique feature of Mass Bamboo is how in all cases the aggregated elements achieve composite action unlike simple bamboo bundles or field built bamboo walls. In additional mass bamboo has unique inter-panel to panel joints, adhesive lamination methods, surfacing methods, and surface furnishing strategies to make panels into full building enclosures from a combination of floors, walls, and roof structures. Reference will now be made in detail to the description of the embodiments as illustrated in the drawings, wherein like reference numbers indicate like parts throughout the several views.

Bamboo holds great promise for low carbon construction in the global south as structural building material. It can be used as beams, columns, or to make wall and floor elements. However, for bamboo to be most useful in larger constructions more innovation is needed. Bamboo could benefit from becoming more regular in shape and size, and this can be done through slight modifications that decrease eccentricities of its form. Processes and considerations have been developed to enable and enhance the structural use of culm bamboo for building and furniture product design, engineering, and analysis. An attempt has been made to use common fabrication tools for wood working as a main approach. These tools are inexpensive, readily available in most global markets, and if tooled and jigged correctly, appropriate for the job.

State of the art bamboo construction can fall into two main categories: “bamboo engineering” and “engineered bamboo.” These approaches can be considered to be two ends of a spectrum of bamboo work: lattice systems and homogenized composites, respectively. Lattice-systems rely on single culms used as columns, beams, and various strut configurations. These projects often leverage the incredible lightness and tensile integrity of the plant to create grand organic and mathematically rich designs. With respect to bamboo's adoption at scale in contemporary green building, the challenges of lattice system approaches are twofold: (1) creating robust joints between poles with a high degree of perceived reliability and (2) developing systems that allow for the tightly sealed, climate-controlled interiors required by contemporary building typologies. These conditions lead to lattice structures that most often are either temporary and open-air or use bamboo in a limited and/or somewhat ornamental fashion.

On the other end of the bamboo construction spectrum, homogenized composites break down the culm into aggregate scrimber, fiber strands, or chips, which are then mixed with adhesive and reconstituted as pressed panels using heat and pressure. While these products have the regularity necessary for the construction of modern tightly sealed interiors, they also disaggregate the plant from its original morphology, eliminating a portion of the structural potential inherent to its growth as a round culm.

Here, a series of building products are disclosed which retain some of the sectional properties of bamboo culms while taking advantage of the panelization common to composite products. One concern includes tracking and analysis of the carbon sequestration associated with this system. The system can be referred to as Smart Bamboo (SB), as it can combine digital sensing, structural analysis, and computational design workflows to create semi-regular, engineered bamboo constructions that maximize the retained natural structural integrity of each culm. A systematic examination of the manufacturing and processing needs for the development of single, multi-species and even bamboo plus other material cross laminated panels is disclosed, including structural testing, machining and production prototyping, pole scanning and modeling, pole splicing, panel connection prototyping, adhesive testing and refinement, surfacing explorations, and the development of computational tools for analysis and design.

This disclosure establishes the basis of Mass Bamboo as a structural building system that utilizes individual pole morphological data and computation to organize lightly modified bamboo culms into reliable structural assemblies. This includes (1) a description of the various panel prototypes produced so far, including preliminary qualitative observations regarding their structural capacities; (2) a description of how these components can be aggregated together in the context of building construction, including strategies for joining panels; (3) how IOT sensing can be used together with computation to optimize the use of an available bamboo stock toward the structural needs of a building; and (4) features that support the realization of a Smart Bamboo complete building system, such as fire barriers, insulation, adhesives, finishes, additional structural testing, etc.

Cross-Laminated Bamboo Panels & Performance

Any comprehensive Smart Bamboo structural system will need a diversity of components to construct an entire building. Just as Mass Timber incorporates a variety of components including cross-laminated timber, glue laminated timber, laminated veneer lumber, conventional wood framing, and heavy timber, a Mass Bamboo system would utilize a number of different bamboo composites and assemblies to create a complete structural building system. To date, prototypes for panels, beams and framed cassettes have been tested that could be applied to floor, wall, and roof assemblies, as well as trusses and stack laminated beams that could provide floor and roof support for long spans. A priority in the development of any of these components is minimizing machining or other alteration of the bamboo culm that may degrade a culm's natural structure or generate excessive waste or byproducts. This strategy aims to reduce energy and labor inputs, correlating to lower environmental and economic costs. Because of the variation of mechanical properties within species, larger sets of testing data may be needed to establish aggregate minimum performance of different species, and a deeper understanding of the impacts of various growing conditions (soil moisture, pH, etc.). To date, structural testing of both single poles and composite assemblies within this system have offered a proof of concept toward the realization of the Smart Bamboo system. Just as cross laminated timber has become the foundational component of Mass Timber construction, the Smart Bamboo cross-laminated bamboo panel can become the foundational component of a Mass Bamboo system. For this reason, this disclosure focuses on the development of this product.

Selection of Bamboo Species. Although no comprehensive evaluation of possible species has been performed, multiple species have been selected based on several criteria; beginning with familiar species. During travels through Asia, including to southern Vietnam, some very solid species were encountered, specifically Tam vong, referred to in English as Iron bamboo, but known worldwide as Calcutta bamboo. This is one of the smaller timber species with an average diameter of under 2 inches (50 mm) and only growing to a total height of around 30 ft (9 m) from ground to tip. It should be noted that the scientific name for the species could be one of two species: Dendrocalamus strictus or Thyrsostachys siamensis. Another species that is used is known in Vietnamese as Tre Gai, or ‘thorny bamboo.’ The scientific name may be one of the two following: Bambusa stenostachya or Bambusa blumeana. Other large woody species were considered that presented similar attributes with regard to size, strength, and availability in the targeted tropical and subtropical regions. This led to work with Guadua angustifolia, a dominant species in the western hemisphere.

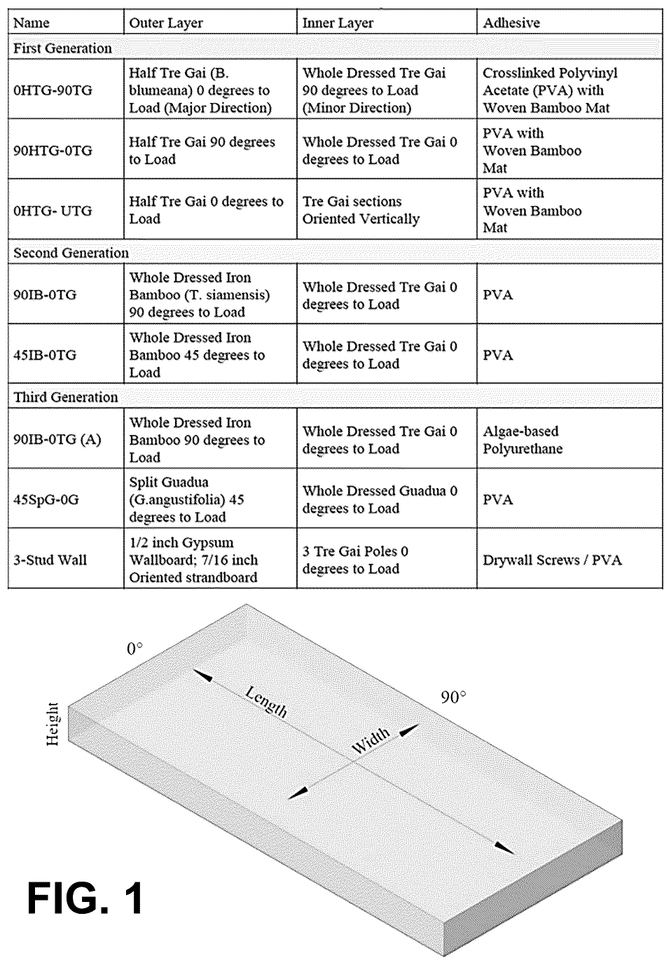

Cross Laminated Bamboo Panel. First inspired by the success of cross-laminated timber panels, it was quickly realized that the effort to create an engineered cross-laminated composite while maintaining the structural benefits of bamboo's natural morphology rapidly multiplied the possible permutations of a cross-laminated bamboo panel beyond that typically found in cross-laminated timber. In an effort to begin understanding the structural effects of different organizations of parts within the panels, several rounds of test panels were created and analyzed using 3-point bend testing to determine the optimal arrangements of bamboo culms within a cross-laminated panel. A series of three-layer panels, 2′×6′ (610 mm×1830 mm), were produced using various permutations of bamboo species, orientation patterns and adhesives. Panel production was divided into three generations which are shown in the table of FIG. 1. The angles are illustrated at the bottom. Each generation tested some basic assumptions about panel performance, with successive generations using the data gained from the previous generation to make further projections about performance and possible improvements to panel organization and assembly.

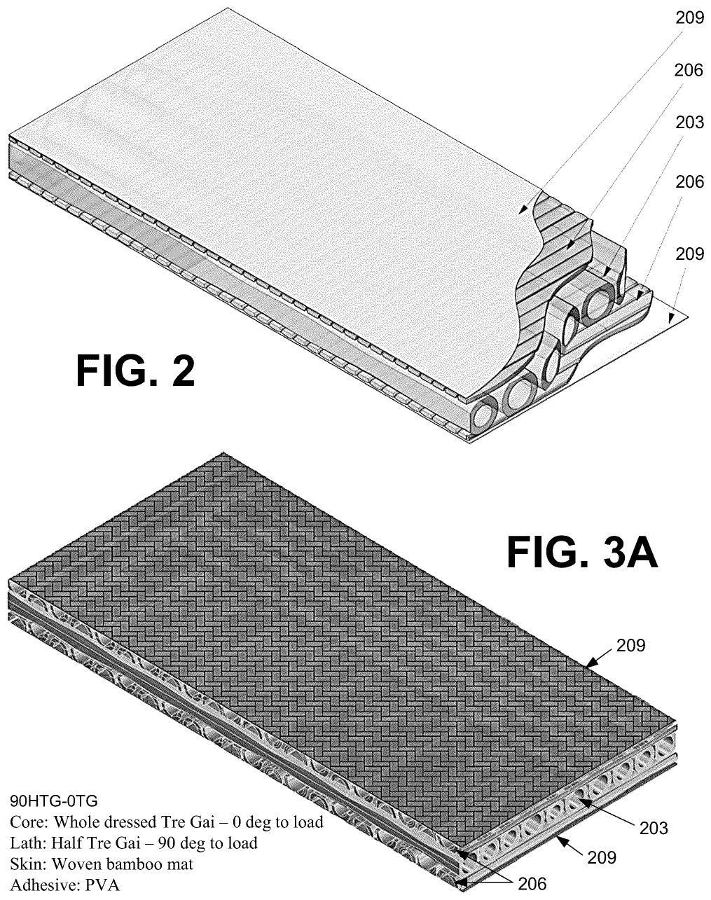

While many variations of culm orientation within each set of panels have been tested, the main structural concept of the panels has remained consistent throughout. FIG. 2 illustrates an example of the smart bamboo panel construction. FIG. 2 identifies the taxonomy of a mass bamboo cross laminated panel embodiment of the present disclosure. The system has been based on a cross-laminated composite comprising at least three layers: a core layer 203, and two outer lath layers 206. While not a component of initial structural testing, a skin layer 209 can be applied to the outer surface(s) of one or both sides of the panel, depending on the surface orientation of interior or exterior, and the needs of the particular panel relative to exposures and programming of the structure. Another part of the system that makes it smart is how pole location and distribution are applied with in the panel layers. Because of bamboo's irregularity, element binning and grading can be performed through light modified processing, than when panels are made each elements can be located based on its potential performance and the needed performance within the panel itself. This fundamentally takes the disadvantage of eccentricity of material characteristics and turns it into an advantage. With bamboo, a mass system can easily be tuned to the specific needs of the construction and significantly reduce the needs for factors of safety often associated with less graded and less variable material stocks.

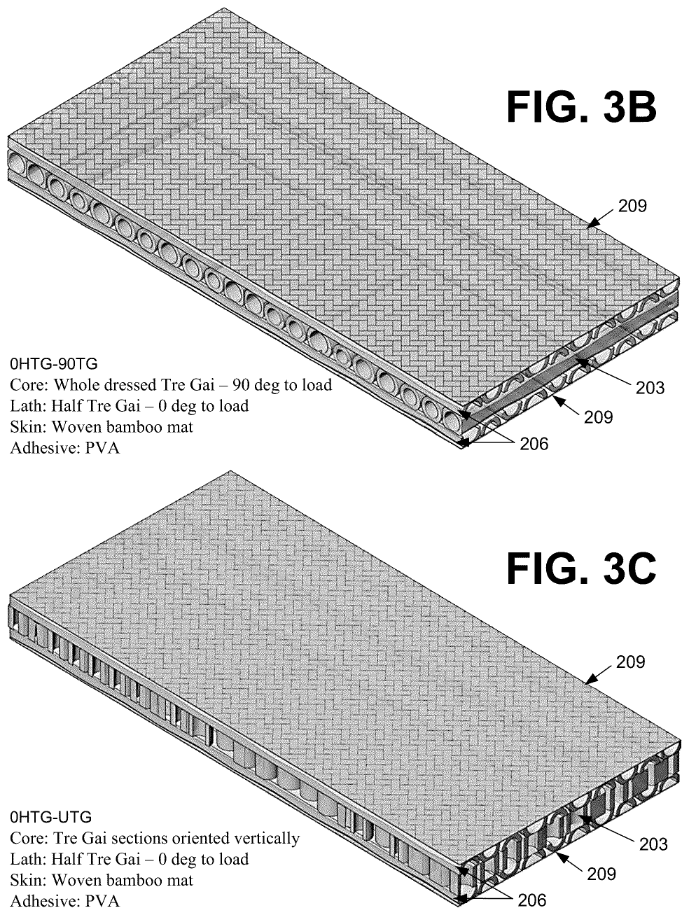

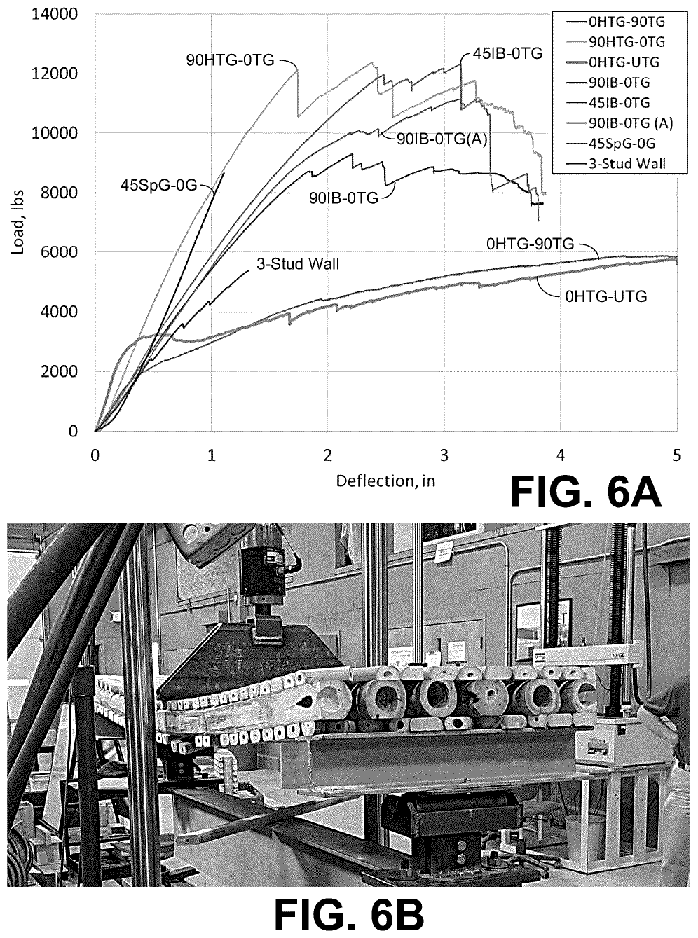

As shown in the table of FIG. 1, the first-generation panels used only Tre Gai (Bambusa stenostachya) for all layers. FIGS. 3A-3C illustrate examples of the first-generation panels. The outer lath layers 206 used a halved culm. The middle core layer 203 in the first two panels (0HTG-90TG and 90HTG-0TG) used a whole pole dressed on two faces as shown in FIGS. 3A and 3B. The third panel, 0HTG-UTG used a middle core layer 203 of Tre Gai sections cut to width and oriented vertically as shown in FIG. 3C. All of the panels in the first generation used crosslinked polyvinyl acetate (PVA) adhesive and a woven bamboo mat between layers. Results of the first-generation tests are shown in the load-displacement curves in FIG. 6A. Surprisingly, the 0HTG-90TG and 0HTG-UTG both had low strength and stiffness compared to the 90HTG-0TG panel and most other subsequent tests. Placing off axis bamboo in the middle layer was found to create excessive rolling shear—much greater than observed in wood and CLT constructions—which dominated the behavior and caused low strength and stiffness. The woven mat product was originally installed in an attempt to increase gluing surface but was also found to act as a failure element, creating a noise during testing similar to frying bacon where the internal structure of the mat failed before the poles.

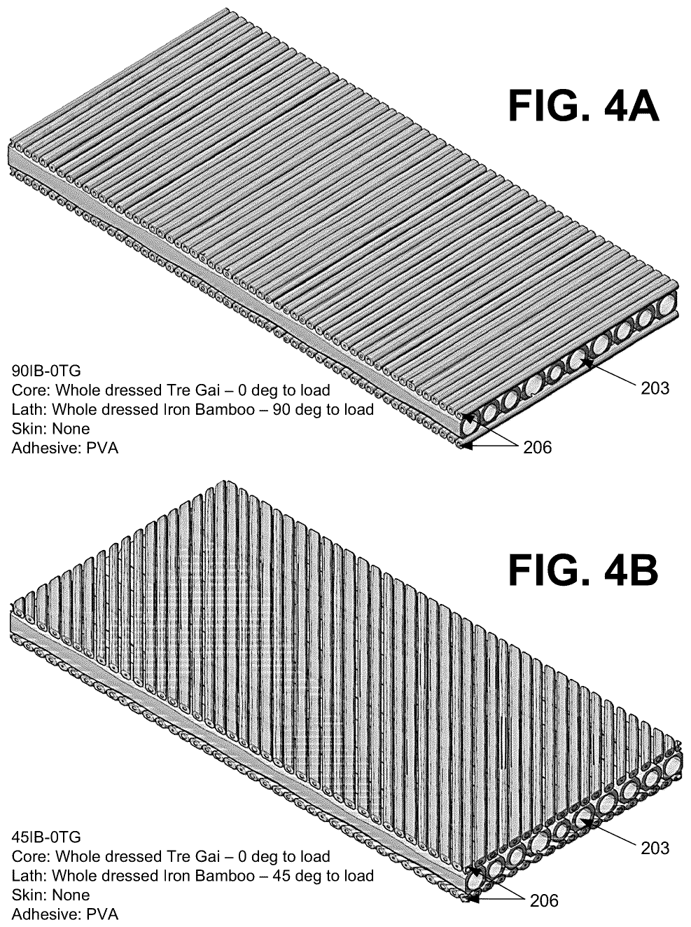

Based on observations from the first generation of panels, the second generation eliminated the woven mat and examined the effect of different cross-laminations in the outer layer. FIGS. 4A and 4B illustrate examples of the second-generation panels. These panels also introduced the use of Thyrsostachys siamensis, or iron bamboo, for the outer layers. Two angles of Iron bamboo were applied −90 degrees to loading, and 45 degrees to loading—as shown in FIGS. 4A and 4B. The 90IB-0TG (FIG. 4A) had a lower load and stiffness than the 90HTG-0TG (FIG. 3A) from the first generation testing, while the 45IB-0TG (FIG. 4B) had a similar load and slightly lower stiffness to the 90HTG-0TG (FIG. 3B). FIG. 6B is an image of the 45IB-0TG panel during 3-point bend testing. The 45-degree outer layer tended to align more bamboo fiber in the direction of loading than the 90IB-0TG sample.

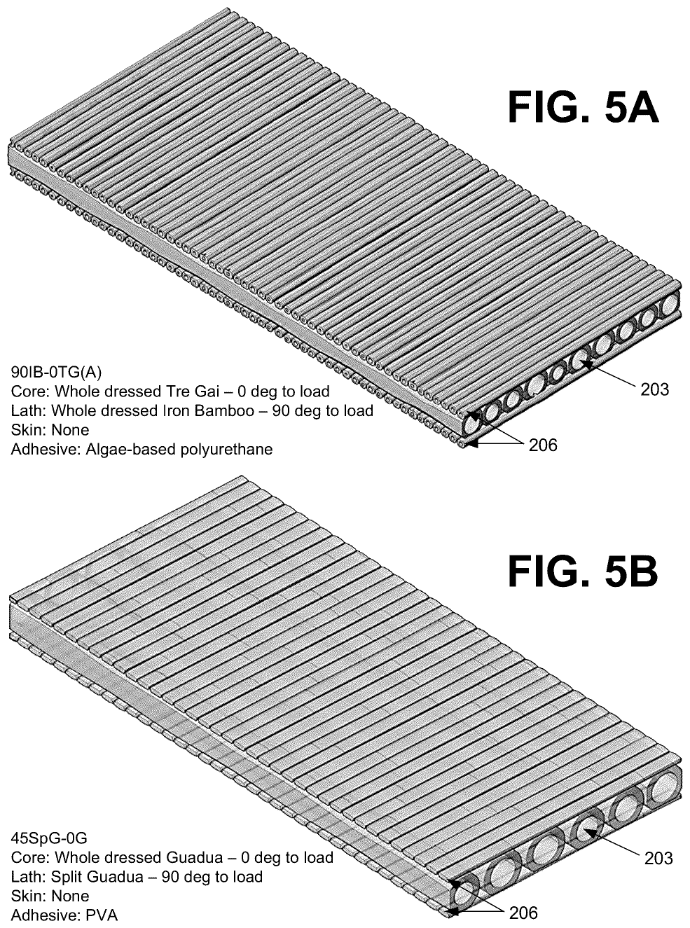

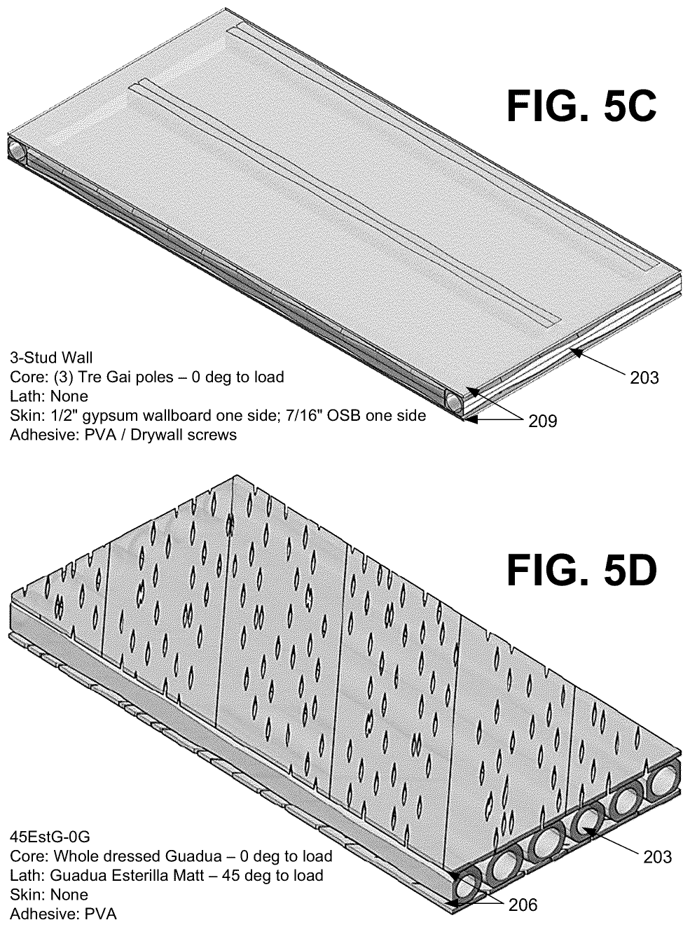

The third generation of test panels explored a variety of other factors including adhesive type, different species and more traditional stud cassette framing common in US residential construction. FIGS. 5A-5C illustrate examples of the third-generation panels. First, the 90IB-0TG panel (FIG. 4A) from the second generation was replicated using a bio-polyurethane adhesive from the California Center for Algae Biotechnology (90IB-0TG(A)) as shown in FIG. 5A rather than the previously used PVA. In an effort to reduce the potential carbon footprint, toxicity and negative end of life implications of adhesive chemistries commonly used in engineered forest product materials. Next, a panel of Guadua (Guadua angustifolia) was constructed (45SpG-0G), using a set of split poles placed at 45 degrees for the outer layer, as shown in FIG. 5B. Finally, to demonstrate similarities with more conventional US residential construction practices, a wall-type panel (3-Stud Wall) comprising three Tre Gai poles with a short Tre Gai section at each end for bearing were covered by ½ inch (13 mm) gypsum wallboard on one side and 7/16 inch (11 mm) oriented strand board on the other side as shown in FIG. 5C. The drywall and OSB were attached with a combination of PVA and drywall screws. Results for the 90IB-0TG (A) and 45SpG-0G panels (FIG. 6A) were similar to the previously tested 90/0 poles from the first and second generations, while the 3-Stud Wall had the lowest strength and a stiffness less than the 90/0 panels, but still greater than the 0/90 panels. It is worth noting that the 3-Stud Wall panel of FIG. 5C is an outlier in relation to the other tested panels in that its primary application within a structure would be a non-load bearing wall, with no application as a floor or roof member. 3-point bend testing with loading perpendicular to the long direction of the panel therefore seems in inaccurate assessment of its intended use. FIG. 5D illustrates a non-tested bamboo panel of Guadua (Guadua angustifolia) with Guadua Esterilla matt placed at 45 degrees.

These test results demonstrate some fundamental differences between bamboo panel design and cross laminated timber, namely a reversal of the typical 0 and 90 layers found in cross-laminated timber to reduce excessive rolling shear in bamboo. The use of various bamboo species demonstrated similar stiffness and strength values for panel construction. Changes in adhesive at this time were inconclusive in demonstrating differences in strength and stiffness. As a preliminary data set, the first three generations of panels tested support the hypothesis that a minimally modified, cross-laminated bamboo panel might perform structurally as well as a comparable cross-laminated timber panel, thus offering a solution for a prefabricated and modular building system for the global south (and or a sustainably manufactured building product made in the global south for a global market) that has the capacity for large scale carbon sequestration.

Addressing Eccentricity. Over multiple generations of panel tests, the observation of bamboo culms, machining of various bamboo species into parts, and the fabrication of assemblies have led to deeper understanding of bamboo's eccentricities. This understanding has in turn led to the refinement of working methods and processes, and the development of further design solutions to maximize the predictability and uniformity of an inherently irregular material. One such solution is the integration of a pole splicing technique into the panel logic as a method for controlling panel stock diameter, thickness, and the straightness of culm sections.

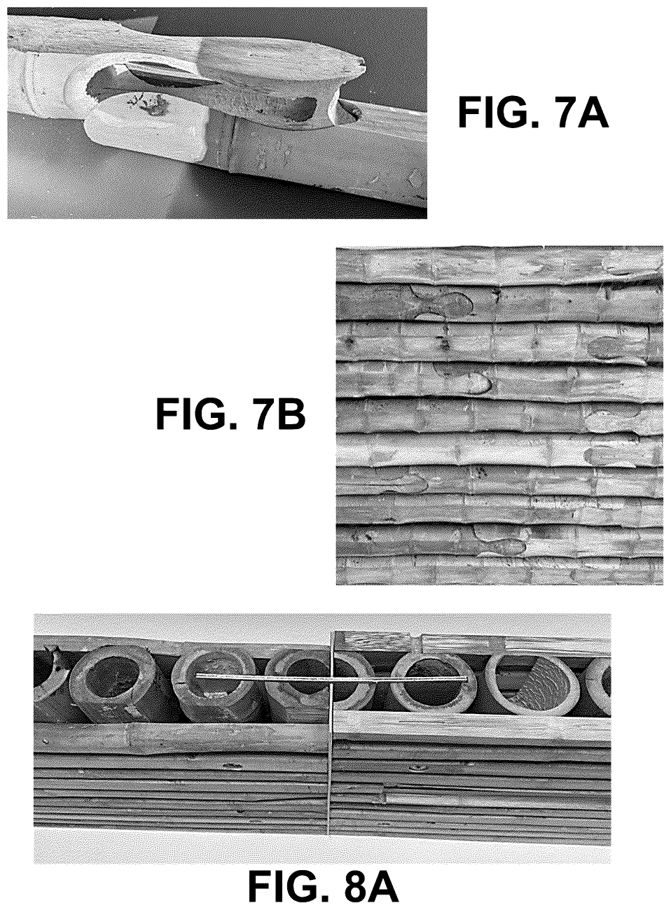

Because the bamboo culm, particularly that of Tre Gai (Bambusa stenostachya), is not straight, and because both the diameter and wall thickness tapers from end to end, facing a culm on two opposite sides in such a way as to maintain an even thickness with an adequate gluing surface is difficult beyond lengths of 6 feet (1.8 m). The facing can provide substantially planar surfaces on opposite sides of the clum that are substantially parallel with each other. Non-straight culms also impact the nesting of parts within a panel, potentially increasing gaps between culms and decreasing the final density and ultimate performance per cross-sectional area of a panel. As a way to compensate for these factors, an interlocking joint was developed that could be quickly cut in alignment with the long axis of the culm using a Computer Numerical Controlled (CNC) router. A splice joint is useful in extending longest and straightest bamboo elements. FIG. 7A is an image of a CNC routed splice joint in two bamboo culms. This enables shorter sections of culm to be interlocked into longer panel parts while providing a means to straighten culms that are bent too far out of axis. The culm or poles splicing joint has unique geometry in consideration of bamboo morphology, it is best to cut the joint where one end of the elements has a concave (or female) geometry while its mate has a convex or male shape. For the female shape it can be cut anywhere along the culm length because it is mostly made up of outer wall, however for the male shape it may only be reliably cut and assembled if the male side of the joints is located with a bamboo node also known as a diaphragm near the tip of the part, this node creates a structural support or column with in the part that support it through machining and glue up clamping, this is a novel method to rejoin bamboo and can be applied to both full round and lightly modified bamboo. FIG. 7B is an image showing a plurality of interlocked culms aligned to form a layer of a panel. This strategy also allows similar diameter and wall-thickness sections of culm to be joined with each other as a way to maintain panel thickness consistency and maximum gluing surfaces. While mechanical testing is needed to validate the structural performance of this method, increasing the reliable straightness, thickness, and glue surface of culm stock within a panel will at least mitigate any negative impacts from the severing of full culm lengths and splicing of smaller parts. This splicing method should prove useful in panel assemblies as well as glue laminated bamboo beams.

Aggregated Construction & Panel Joinery

After validating the structural potential of Mass Bamboo with the second generation of test panels, parallel investigations were begun to develop methods for scaling the system into aggregated constructions. Multiple iterations of full-scale installation designs were developed with the intent to test a variety of panel-to-panel assembly conditions at something closer to the scale of a building. A design was selected which presented the opportunity for the fabrication of larger panels up to 3′×10′ (1 m×3 m) and the testing of a variety of panel joint conditions. The installation was designed at a scale that would encourage human engagement, both to test the durability of construction and to promote interest and exploration from those engaging with the assembly. Joint prototypes were developed and assessed for ease of fabrication, reliability and durability.

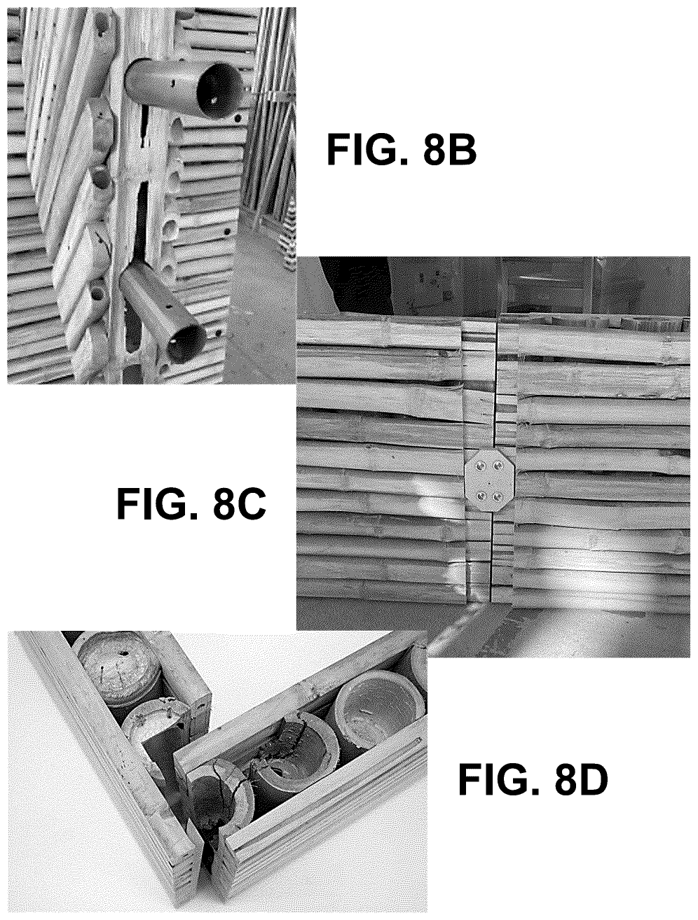

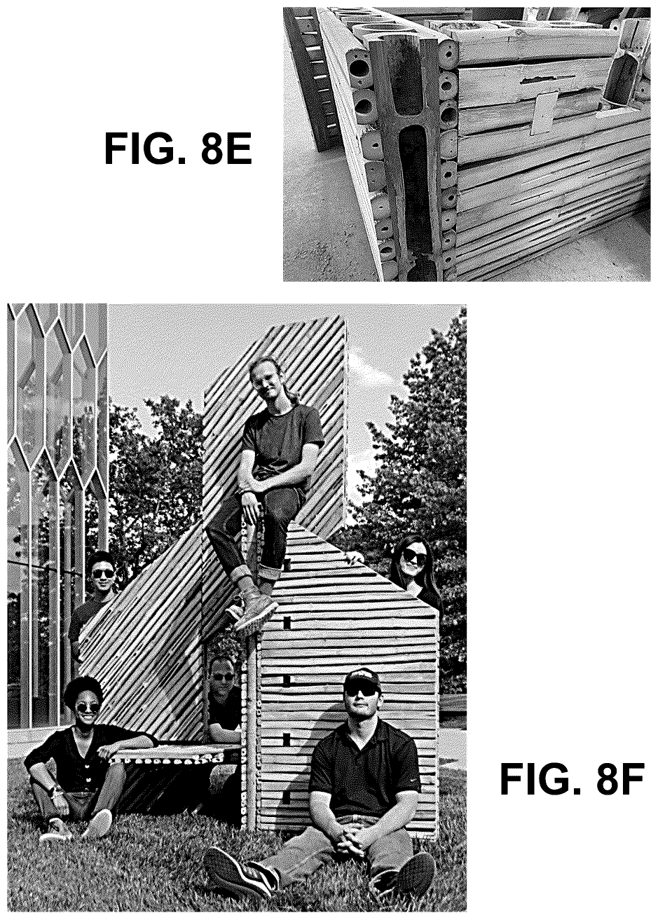

Joinery Development. A variety of joints were developed for prototyping that could accommodate the connection of panels (1) edge-to-edge in a linear assembly, (2) at right angles with one panel ending into another, (3) at right angles with one panel crossing over another, and (4) at right angles with one horizontal panel intersecting one vertical panel. In a linear assembly, edge-to-edge butt joints were considered with both internal and external mending plates. The internal method comprises cutting a thin slot along the entire length of both edges with, e.g., a skilsaw, inserting plywood as a splice, and then bolting all the way through the panel and plywood on both panels. FIG. 8A is an image of a fabricated internal edge-to-edge splice joint extending through the core layer of two adjacent panels. The external method comprises cutting shallow reliefs along the length of the front and back panel edges using a CNC, aligning plywood splices on either side, and bolting through the panel and splice(s) on both panels. In another embodiment, an edge-to-edge can be formed using bored holes into which a piece of 1½″ diameter EMT conduit pipe (or wooden/bamboo dowel) can be inserted and cross bolted through each panel to secure the end in alignment as shown in FIG. 8B. FIG. 8C is an image of a fabricated external edge-to-edge splice joint extending through the lath layers of two adjacent panels. The prototype of the external plate was unreliable due to the bolts being too near the edge of both panels, providing much less strength than the internal method which allowed hardware to pass through the second pole in from the edge of the core layer. While the detail could have been adjusted to increase the fastener distance from the edge, the internal method was preferred for ease of fabrication and aesthetic considerations.

For the corner condition, joints were tested as both a rabbet joint and a corner butt joint that utilized inserted wooden bucking blocks for fastening. The rabbet joint comprises cutting a deep shoulder, almost through the entire middle core layer using a CNC, to receive the second panel. Lag screws were then driven through the remaining lap on the rabbeted panel and into the unaltered panel. FIG. 8D is an image of a fabricated rabbet style joint for alignment with the end of the adjacent panel to form the 90-degree corner. The butt joint was a similar process but requires less machining. Rectangular openings were cut to size in strategic locations along the panel edge, and a bucking block was inlaid, providing a solid mass of material for a screw to be embedded reliably. FIG. 8E is an image of a fabricated butt joint aligned with the end of the adjacent panel to form the 90-degree corner. Without this bucking, the majority of threads on a screw are likely to end up in a void in the bamboo and fail to provide a reliable connection. Ultimately, the butt joint was chosen because it requires the least machining and therefore had the highest material and labor efficiencies. Although rabbet joints are commonly considered more robust in furniture design, the butt joint can be more reliable because it does not have the additional risk of delamination.

As a right-angle condition with one panel crossing over another, a simple slot joint was produced. This was fabricated using a 3-axis CNC router with a three-inch wide straight two-flute cutter to provide an initial rough out, and then a smaller diameter cutter to machine cleaner internal joint edges. Although a CNC process was used to create this joint, this joint is simple enough to be cut using analog tools such as a framing skilsaw, handsaw, or a combination of the two.

Full Scale Installation. After testing prototype joints at a smaller scale, large panels were fabricated for the construction of the installation assembly. FIG. 8F is an image showing an example of a full test structure fabricated using smart bamboo panels. While the simple slot joint and butted corner joint were replicated in this construction nearly identically to those produced in the prototype tests, an edge-to-edge splice was developed which used bored holes and an inserted piece of 1½″ diameter EMT conduit pipe cross bolted to secure through each panel (see FIG. 8B). A large mortise and tenon like joint was used to embed a bench component horizontally on the faces of larger panels. The main challenges throughout the panel fabrication process were pole sorting and selection, layer nesting for panel assembly, and panel edge trimming.

Selection of tre gai for the middle layers was determined by a desired diameter of approximately 3.5 inches (90 mm). This most often resulted in solid faces when machined, due to wall thickness being rather consistent over the length of a 13 foot (4 m) pole. The Iron bamboo, on the other hand, proved more difficult to sort consistently. The available stock of iron bamboo includes 6 foot (1.8 m) poles and 18 foot (5.5 m) poles. The 6 foot parts were mostly cut from the same culm section as the lower segments of the larger poles, and therefore have a consistently larger wall thickness, some nearly solid all the way through. The 18-foot poles ranged greatly in diameter and wall thickness from base to top, with the top 6 to 8 feet have walls that were almost too thin for panel applications. A proper sorting and grading system was needed to be implemented for the iron bamboo because these thin walled poles create limitations for reliable fastening to the panel, lacking in local compressive strength of the outer layer.

Another challenge of fabrication at this scale was nesting of culms in each layer, more so for the tre gai middle core layer. While tre gai culms were selected to achieve target thicknesses and provide substantial surface for glue adhesion in each panel, the relationship of node locations in each culm should be considered to project joint locations between panels. For example, fabrication of the slot joint in a final assembly left a thin sliver of a Tre Gai pole on one of the final panels, which was at risk of breaking off through repeated assembly of the joint, compromising the joint resilience and potentially contributing to further delamination of the panel itself. The location of joints needs to be considered prior to panel fabrication and parts intentionally placed such that machining provides adequate bearing surface and node positioning that provides durability within each part.

Bamboo Beams

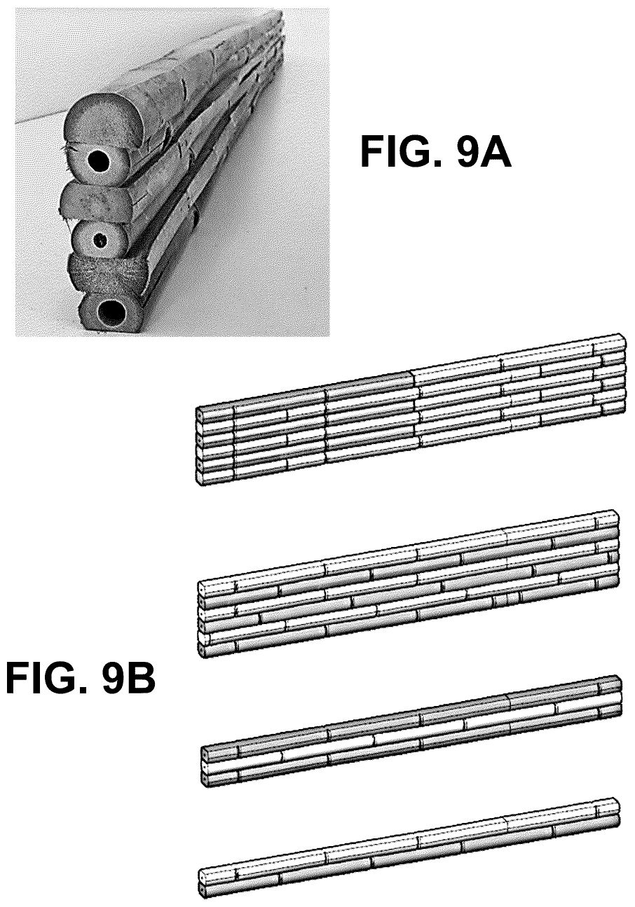

Although the Mass Bamboo system has been described as bi-directionally mated layers of lightly modified bamboo elements, it is also practical and useful to create composite action with unidirectional laminations. For example, bamboo beams can be fabricated using the describe methodology. FIG. 9A is an image of an example of a bamboo beam fabricated with iron bamboo. The beam and comprises six faced elements with approximate dimensions of 1.5″ side, 6″ high, and 6 feet long. The thick and thin ends were flipped to achieve a balanced result.

These elements can be bonded together creating composite action by way of some or all of chemically by, e.g., gluing or mechanically through, e.g., screwing, bolting, stapling, and winding/lashing. Unlike traditional bound and/or bundled elements together through attachment from bonding and mating faces, the stacked bamboo beams are more than a bundle because of composite action. As a result, it is possible to have higher stiffness and to develop units with staggered joints that can run indefinitely in length as a single structural member of an accurate depth and modulating but regularized width of the bamboo has been properly binned and selected for a beam. Also, grading the location of the elements to tune the beam and to use various staggering and flipping considerations of tapered elements in stacks can achieve results that make a far more mechanical and size uniform beam from bamboo that still has a great deal of eccentricity in the natural uncut regions of the round like surface. In this way, the beams are able to minimize waste and maximize tunability, consistency, and easy integration into other building materials, and systems because of their increased flatness and a general increase in uniformity. FIG. 9B illustrates examples of various staggering strategies that can be used to provide limitless beam lengths of glued elements. The staggering can minimize any negative impact of butted seams within any one layer of the beam.

BioMass Bamboo Composites

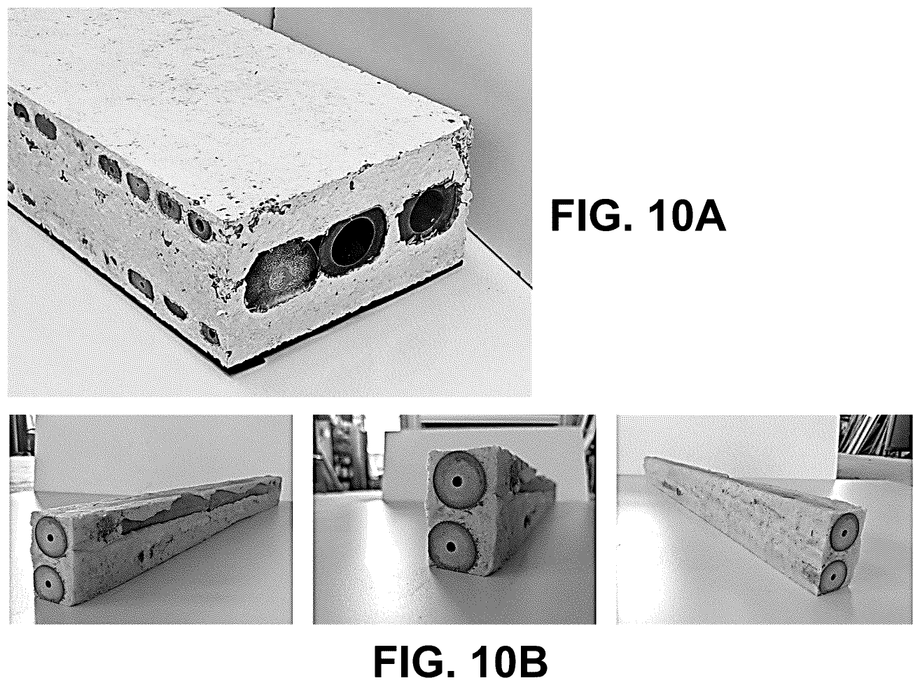

BioMass bamboo structures (e.g., Bamboo Mycelium Composite) have also been considered to determine if bamboo could be grown together with, e.g., oyster mushroom mycelium to bind the bamboo together. Made in a wood box mold, a first-generation prototype was generated that measured approximately 8″×12″×18″ long as shown in the image of FIG. 10A. The composited structure exhibited moderate success, however once the mycelium growth was suspended by heating and drying the composite some delamination occurred. This avenue along with algae adhesives may provide more sustainable and nontoxic composite strategies to typical use of adhesives such as, e.g., PVA, Epoxy, and Urethane of Phenol Formaldehyde. All of these adhesives have also been explored and produced mechanically sound results. Presently Mycelium (roots of mushrooms) was the worst-performing method in terms of mechanical composite action and adhesion, however from a toxicity and embodied energy point to view they have some potential advantages.

In addition, a cast polyurethane foam approach has been developed for fabricating composite structures. In this process, uncut bamboo elements can be molded together (e.g., using a frame). After the foam or other matrix cures or cools, the molded elements can be trimmed to dimensional size. In some implementations, trimmed or lightly modified bamboo can be used. For example, the images of FIG. 10B show a small two-layer beam fabricated using cast polyurethane foam. This approach can also apply to larger beams and cross-laminated panels, or even framed wall cassettes, where the modification is mostly additive, not subtractive.

Parameterized Bamboo

As illustrated above, one of the biggest obstacles to the use of bamboo in a standardized construction system is its structural variation. While this proves an undeniable challenge for consistent and reliable work holding, machining, and precision modification of the bamboo culm, this variation is also an opportunity for the integration of bamboo's natural structural intelligence within the design paradigm of mass-customization. Through computation and digitally assisted manufacture it is possible to integrate this variation into a process that results in a rich design vocabulary informed by the specific qualities and performativity of the material at hand. Using IOT sensing technology, such as photogrammetry, laser scanning, and others, each piece of bamboo stock can be scanned 190 and cataloged in a real time and on-demand digital library. This library of available stock can then be integrated into a computational script that uses evolutionary solvers to find the most appropriate bamboo culm for each member of an assembly based on a set of assigned criteria.

Beginning with an ideal structural model or overall design, the script can analyze each piece of the stock in the library to optimize its placement in areas of the structure where their morphological qualities will be most appropriate and generate an inventory of needed parts. Bamboo stock can be sorted by diameter and correlated wall thickness in order to assign denser and more reliable stock in areas of greater structural demand, and stock with less integrity or performance value in areas of lower structural demand. In a process of generative design, the form of the structure itself can be computationally tied to feedback from pole morphology. Node positions along each culm can be analyzed to optimize part placement to align nodes with optimal areas that increase the strength of joints between components and also adjust the form of the structure if necessary to create optimal nodal relationships. These computational tools have been developed with a focus toward lattice-systems, but the same algorithmic logics can be readily applied to the panelized Smart Bamboo system presented here.

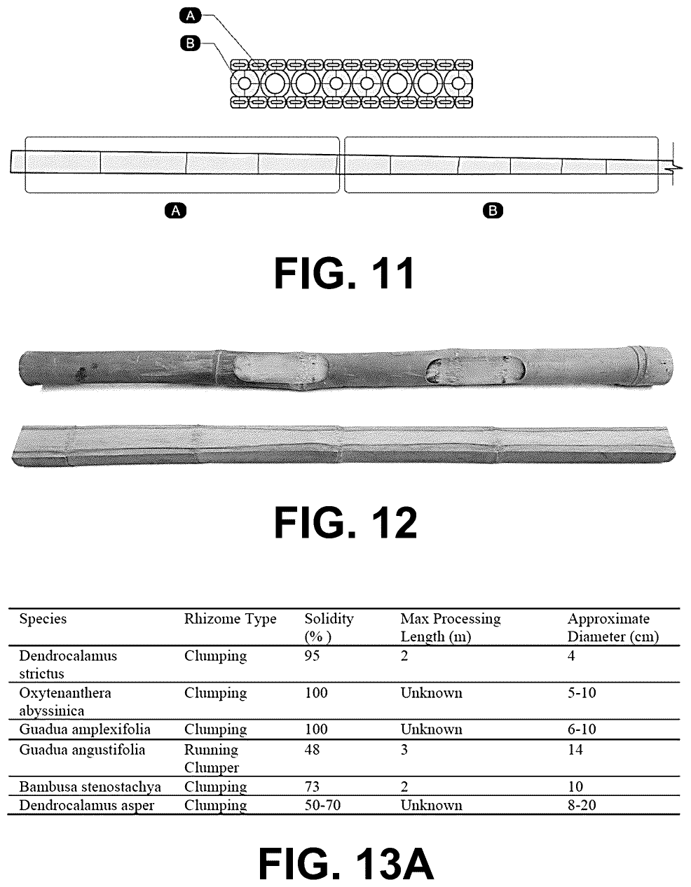

In order to optimize the use of available bamboo stock, parts can be analyzed for node location, node spacing, straightness, diameter, and projected wall thickness. Node location and spacing can suggest arrangements that lead to more efficient nesting of materials within panel layers, as well as positioning nodes in locations where they will help to carry loads and create solid fastening points for joint connections with other panels or components. Stock can be sorted by variations in pole straightness in order to promote efficient packing, suggest pole splicing locations, or potentially suggest culms with more drastic curvature to be placed in regions of panels that may benefit from voids such as, e.g., openings for fenestration or utilities. The diameter of stock can be correlated with data from structural testing in order to grade stock by its potential structural performance. FIG. 11 illustrates an example of a core layer 203 of a panel that alternates pole sections with different wall thicknesses. Combinations of different wall thicknesses can also be considered to reduce weight while maintaining structural strength.

Using this grading information, stock can be placed where it is most appropriate within an assembly. This can mean placing particular pole stock strategically within a panel, but also within a larger structure. For example, different portions of a bamboo pole can be assigned for construction of different panel thicknesses and dimensions. Once the analysis is completed, various pieces of the pole stock can be processed using, e.g., CNC routing or other appropriate machining or processing to generate the completed parts which can then be assembled into the final structure.

The gathered data indicate that Smart Bamboo as a structural building system, can improve the means and methods of manufacture and assembly. Aggregated quantitative testing data can verify reliability of structural performance and establish a standard engineered product. The use of non-invasive grading tools and processes can facilitate reliability and repeatability. Inclusion of a robust fire barrier system can allow the system to be utilized in mid-rise structures. Moisture/vapor barrier strategies can also allow building enclosures that comply with contemporary performance standards. The use of bio-adhesives can decrease the proportion of non-organic materials used in the system. Design of the bamboo panels can allow for building features and infrastructure, including fenestration, mechanical, electrical, and plumbing systems. In addition, the application of building finishes such as interior wall finishes, exterior cladding finishes, and floor and roof surfaces can offer improve habitability of the structures.

Modifying Thick-Walled Timber Bamboo

The phrase lightly modified bamboo has been used to describe a range of approaches to constructing contemporary vernacular bamboo structures. This term initially had a broader meaning, focused on many processes and assemblies that only partially disaggregated bamboo and were performed by traditional bamboo carpenters in the field. Under this broader definition for lightly modified bamboo, one might refine culms through a variety of methods that include cross cutting, end joining (i.e., fish mouths), bundling, splitting, and/or unrolling bamboo (crushed bamboo mats known in Spanish as Esterilla). These processes are mainly strategies used to create elements that differ from natural bamboo culms with methods that could be deployed manually with very basic technologies and/or on the construction site. However, this term can inspire a refined set of elements and processes with which can offer a fully industrial approach.

Here, two approaches to modifying bamboo are described: one with analog machinery and the other with digital tools. FIG. 12 includes images of an analog modified bamboo culm (bottom) and a digitally modified bamboo culm (top). These approaches have been advanced from two different research trajectories, one to composite bamboo culms with an approach termed Mass Bamboo and the other for Standardless Material fabrication. An exploration has been made of methods with which bamboo can be delicately altered to keep most all its benefits but offer broader choices for design and construction.

Species and solidity. To maintain as much biomass as possible, certain types of bamboo are more relevant to lightly modified bamboo. Here, the focus is on woody tropical species that have moderate to thick walls, the most exceptional of these species can be characterized as having high solidity. Along with high solidity, it is also important to cut the bamboo down to workable lengths. This is species dependent and may be impacted by culm stiffness and outer morphology, such as diameter, straightness, roundness, and taper. Additionally, because bamboo is mostly but not completely solid, an equal consideration is placed on the inside diameter. Therefore, wall thickness is a fundamental determinant for viable species and sizes of parts. Qualitative research with Tre Gai Bamboo in Mass bamboo panels and with lightly modified bamboo culm 3-point bend testing suggest that much of culm bamboo stiffness can be retained even if a culm is cut flat on one or two sides as long as there is significant preservation of initial cross-sectional area.

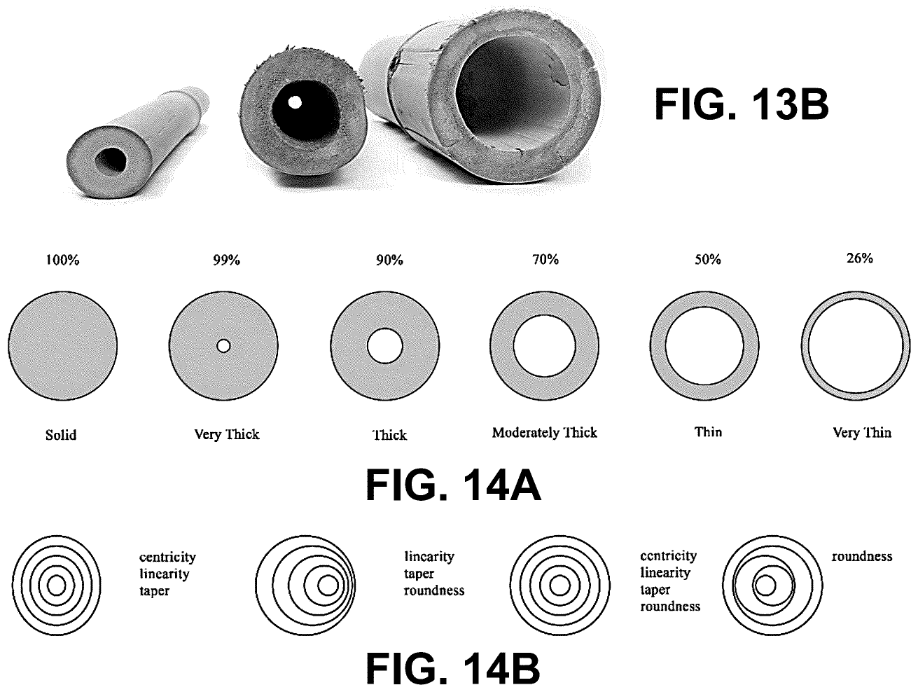

Finally, the basic morphological structure of bamboo can be retained. Bamboo should be maintained as a transversally semi-closed shape and have its nodal structure mostly intact. Similarly, the major structure of the culm should be kept intact for lightly modified bamboo to be safely performed and rendered useful. FIG. 13A includes a table contextualizing various bamboo solidities, which describes the species that have been explored. FIG. 13B is an image illustrating examples of the bamboo species of Dendrocalamus strictus, Bambusa stenostachya and Guadua angustifolia. This is not meant to be a comprehensive list of useful bamboos, but instead to share how the procedure may work with different species that have been observed, researched and/or that have been manipulated.

Analog Facing

Initially developed for the advancement of cross laminating bamboo, a method for analyzing and facing bamboo may offer others great utility in regularizing some geometric features useful for aggregation. This section provides concepts and methods to safely create the basic element of lightly modified bamboo with analog tools and jigs.

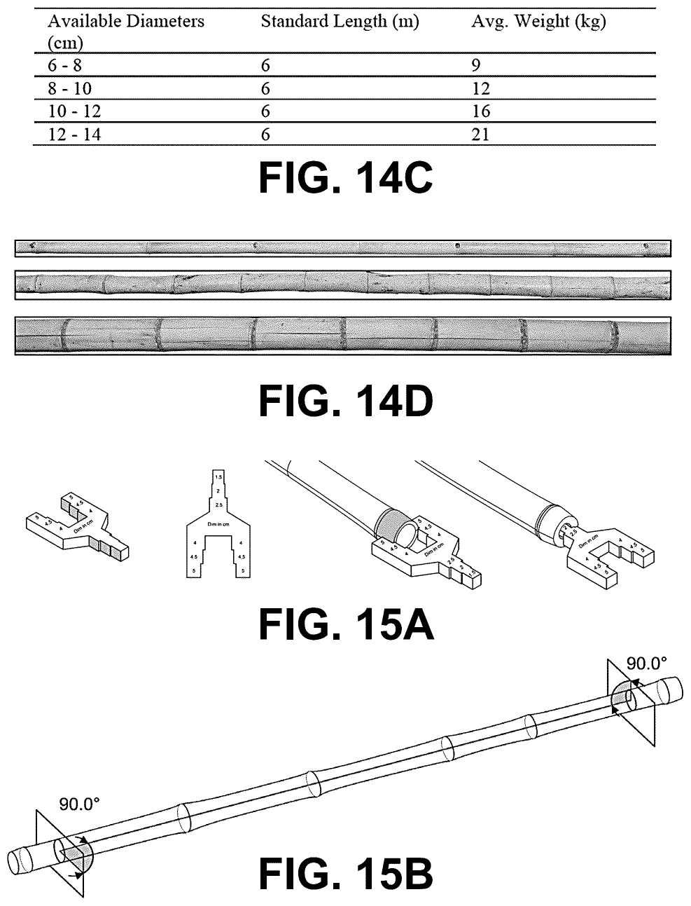

There are multiple factors that make a species productive for analog faced lightly modified bamboo. The obvious one is that the diameter and stiffness should meet the needs of the design, mechanical, and geometric requirements. The next most important factor relates to the bamboo's average cross-section solidity. High solidity is ideal to be a variable species for lightly modified bamboo and this translates to a minimum range of 45%-65% solid. This includes species that range from the highest end of thin walled to solid, as classified in plant science. FIG. 14A graphically represents the average cross section correlated to solidity percentiles and terminology identifying the ranges.

Of equal importance are the characteristics of: (1) centricity, (2) linearity, (3) taper, and (4) roundness of the bamboo. These aspects in aggregate are what determines what size, lengths, and number of faces can be achieved when reducing natural bamboo into analog faced lightly modified bamboo and will be further discussed below. FIG. 14B graphically represents the geometries that result in the bamboo irregularity and identifying terminology.

Size Sorting and Grading. Commonly, bamboo as a building material is grouped and sold by approximate outer diameters. This is referred to as grade or grading, however there is not a universally accepted method to define grades. Different approaches may be used depending on profession and locality.

A single grade size with some species and suppliers may vary by 1-4 centimeters from piece to piece within a graded size. This is for two reasons: natural variation and lack of a global standard. For example, Dendrocalamus strictus only yields usable material for construction of up to about 3-5 cm in diameter and is sometimes sold as one grade. However, Guadua angustifolia grows much taller and wider and thus has more grades. FIG. 14C shows a table based on one seller “available diameters”, in which four grades are listed based upon graded sizes that vary by 2 cm. Bamboo may also be graded and sold in different lengths from 2-6 m, and with the larger lengths in this range there can be significant variation in diameter from one end to the other of a length.

Cutting to Length (Cross Cutting). Due to variability of grades more sorting, cutting, and categorizing is needed to organize bamboos into outer diameter that can be faced to be parallel. The first consideration is bamboo outer diameter at the smallest ends should be sorted into groups with maximum variation of only 1.5 cm before any other processing occurs. Next the stock should be divided into consistent length units. Note that the max lengths of elements will depend on linearity and solidity. FIG. 14D illustrates a range of out of straightness for three different bamboo species.

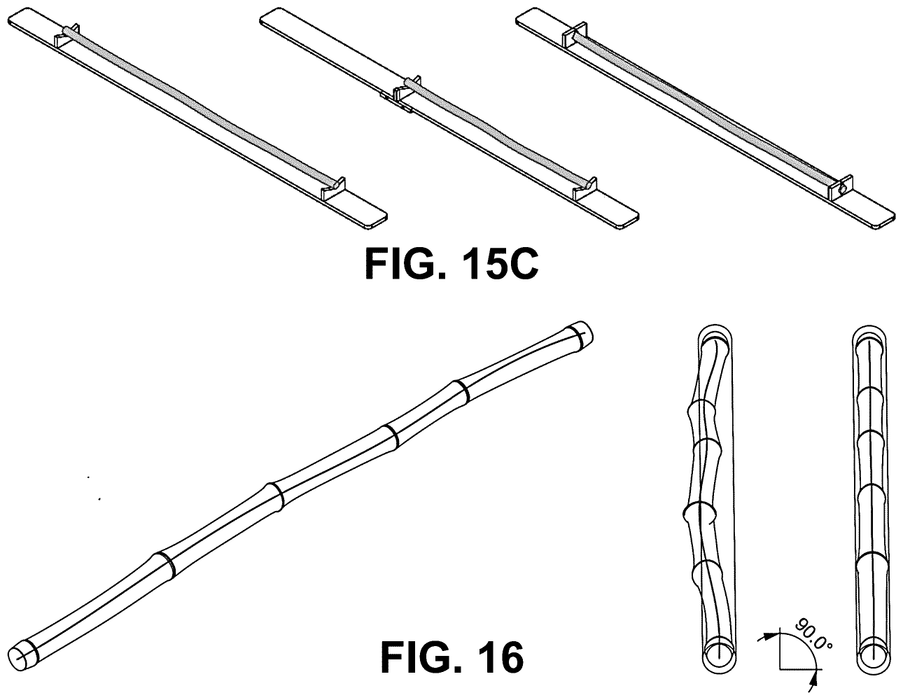

Further Sorting (Binning). In order to bin, cross cuts can be made to finished lengths to allow a visual opportunity to look at wall thickness of the bamboo. At this stage, a second categorization step can be performed in which both outer and inner diameters are observed with, e.g., a jig that confirms acceptable diameter and wall thickness. FIG. 15A demonstrates an example of a jig that can be used to bin bamboos with similar and acceptable sizes for different thicknesses. For example, the bamboo can be binned in intervals of 1 cm or other define interval. These binned elements will be ready for ripping, and typically each bin can be ripped to a specific width.

It's also helpful that at least one cut on each final length element is not made at a node to prevent an inaccurate presentation of wall thickness. This normally happens when cutting to repeated and fixed lengths because of the natural variation of bamboo morphological structure. In final fabrications however this should be balanced with the possibility of terminating at a node, which has several benefits including structural and aesthetic integrity and reduction of waste. If all cuts are at nodes, then the density of the bamboo is generally a reasonable indicator of wall thickness and weighing the bamboo may be a helpful alternative method to estimate acceptable minimum wall thickness.

Cross cutting has unique challenges because of bamboo eccentricities making it unusual to support on a cross cutting saw of any type. When bamboo sections are crosscut at each end the desired result is perpendicular cuts along a theoretical centerline in the longitudinal directions. FIG. 15B illustrates an example of parallel cuts on bamboo perpendicular to the theoretical centerline. This center should be established in two-dimensions as seen at the lower left side of the FIG. 15B representing the horizontal axis set at 90 degrees. Due to bamboo eccentricities of shape, there may be no benefit to also cutting at 90 degrees in the second/vertical orientation for analog facing of bamboo, shown in the upper right part of FIG. 15B.

Due to bamboo's irregular shape, cross cutting can be dangerous without the correct jigs. When cut with power tools, it can exert uneven tension against the blade and kick back. However, with a crosscut jig, accurate perpendicular cutting is made easy, fast, and safe. FIG. 15C illustrates examples of cross cutting work holding methods: semi fixed-2D (left), length adjustable-2D (middle), and double self-centering 3D (right). Cross cuts with these methods are possible at nodes or internodes, and for a good quality of cut, tearing out and burning should be avoided. These are impacted if the blade is not sharp enough or the tooth geometry of the blade is not meant for cross cutting.

A variety of setups can be used with the crosscut methods such as manual, push saw, metal cutting hacksaw, and pull saw. It is also possible and productive to use electric power saws ranging from, e.g., a cross cutting band saw to several saws with circular blades. For cross cutting the blade type is not of particular concern as long as the cutting parameters do not damage the saw blade or produce poor results.

The way the work is supported has a direct effect on the quality of the final results. Several jigs have been explored to support and align the work piece for cross cutting with the objective to produce two quality cuts one at each end of a length while the element is fixed to a jig. Furthermore, these cuts can be used to establish the theoretical centerline of the element.

Several experimental jigs and hacked tools have been examined with the final process using a shop made V-block to support the bamboo and cut it on an electrical crosscut capable saw. The jig for cross cutting analog faced bamboo normally can be used to make many parts at the same length and thus is a semi fixed jig for cutting lengths, intended to make many elements at the same length. Note that for the cuts to accurately establish the theoretical centerline and to be coplanar, then each element should have fresh cuts from the initial stock on each end.

Longitudinal Facing. Evaluating Straightness. Once bamboo elements have two coplanar cuts and are sorted where all units are very similar in diameter, wall thickness and weight per bin, one other aspect should still be considered. This is evaluating rotation position along the longitudinal length of the culm to determine which axis or orientation is the element's flattest one. Most bamboo kinks, undulates, or grows with a slight spiral-like twist. This is especially true of high solidity species and can be distilled down to the consideration for which orientation has the most significant curvature. When parallel to this direction, the elements are reasonably flat.

This step can utilize visual sighting down the length to observe linear verses arcing geometries. If culms are very straight and have high centricity and linearity, they can be cut with infinite numbers of faces or in any orientation. This, however, is rarely the case, especially with high solidity clumping bamboo species, and therefore one should consider which direction the bamboo should be faced in. A slightly arching culm can be very flat when cut parallel to the natural arc, and therefore can receive two faces.

FIG. 16 illustrates an example of how a bamboo element can be flat in one orientation but not in others. A single element is illustrated in three drawings from different views, notice how in the far right view the element appears straightest. In this case it would be the orientation to receive parallel ripped faces.

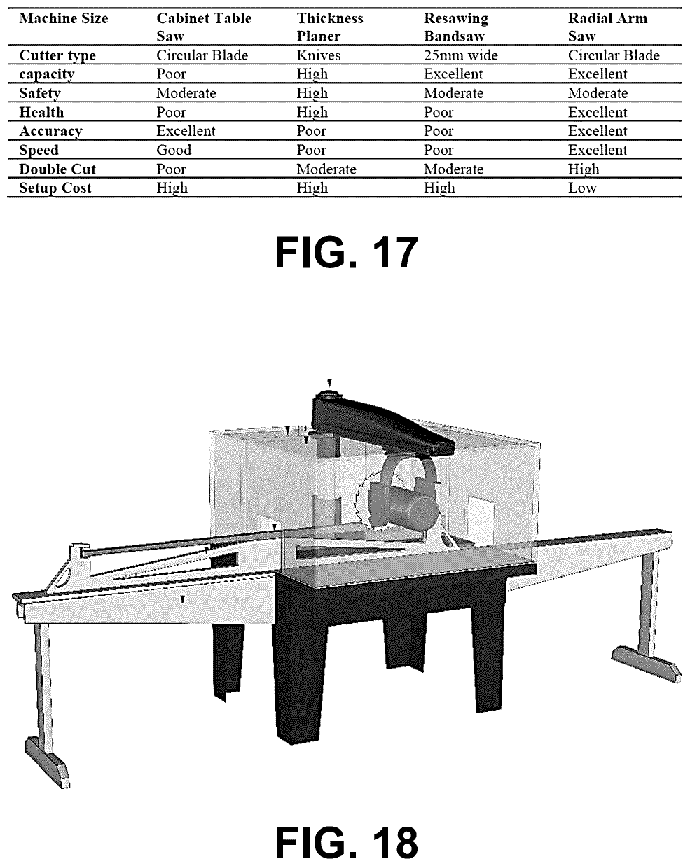

Sawing Methods. In order to face bamboo, holding the work securely in place is important. Multiple approaches have been explored and a best practice has been established. This best practice may be defined as one that adequately achieves a series of priorities at the fabrication or research scale: (1) to be safe to the machinery operators by reducing or eliminating risk of bodily injury, (2) to eliminate cause of excessive noise and eliminate open air disbursement of fine particulate bamboo sawdust which is harmful to eyes and the human respiratory system, (3) to produce accurate results, (4) to be achievable with low skill (5) to be fast and repeatable to achieve, (6) leverage inexpensive and available technologies found in a common carpentry or wood working shop. FIG. 17 includes a table illustrating a qualitative overview and evaluation of tools for facing bamboo.

Bamboo has traditionally been split as a means to longitudinally disaggregate or flatten; however, its grain does not run straight through nodes, so this process was not strongly considered for the facing application explored within. On the contrary subtractive processes can make cuts in any orientation irrespective of grain orientations and thus have been explored. Three general cutting approaches have been tested: (1) bandsaw cutting, (2) thickness planning and (3) circular sawing.

In each case a jig was utilized, and the goal was to produce a finished face in one pass per side, and ideally not remove elements from the jig. The band saw was initially explored and rejected as a viable process for the following reasons: (1) extremely poor dust collection, (2) low accuracy caused by blade kerf and drift, and (3) requirement of a second process to produce finished surfaces. A thickness planer was also evaluated as a sole process and rejected due to the need for complex jigs, many repeated operations, difficulty achieving repeatability, and difficulty attaining flatness because of material deflection.

The table saw tested carried a 254 mm (10″) diameter blade and the saws published maximum depth of cut was 80 mm (3⅛″). Because the nature of the cuts the actual stock that can be ripped was larger and it is possible to rip bamboo with a cut depth of up to nearly 8 cm, allowing bamboo with a diameter of approximately 10 cm to be faced on a table saw with a blade of 254 mm. However, the jig that can produce such a part relies on the fence and needs repositioning of the bamboo and the fence for each cut. This makes accuracy a challenge and is a slow process per part. Furthermore, with the bamboo not in contact with the table at the edge of the cut, neither the standard in table or above table dust collection can be used.

Ultimately, a circular blade ripping method was chosen because a finished face could be established in one operation. When considering appropriate saw types, the first one tested was a table saw which was effective for smaller outer diameter species at very short lengths (under 75 cm) however as lengths and diameters increase a common carpenter's table saw was ineffective due to lack of available blade depth of cut of under 8 cm.

Radial Arm Saw. When considering alternative ripping saws, a Radial Arm Saw of a comparable size was explored and offers significantly more cutting capacity of approximately 15 cm. Furthermore, a Radial Arm Saw also affords a more stable structure for jigs, and easily accommodates a dust enclosure. A jig for quickly and accurately holding and aligning the bamboo culm is used to allow an operator to pass the bamboo through the saw blade and make the facing cut. If bamboo is straight and solid enough it can be ripped in lengths up to 2.43 m. It should be noted that Radial Arm Saw can cause ejections if not used properly. Particular care for work holding, blade alignment parallel to fence, and blade sharpness needs to be maintained and in accordance with manufacturing instructions for safe saw operation. Although no tool is without any risk or danger if used incorrectly, the Radial Arm Saw in rip mode, equipped with thoughtful jigs and enclosures is the fastest and safest way to accurately face bamboo in the laboratory or workshop environment. FIG. 18 illustrates an example of a Radial Arm Saw (RAS) including dust box and a jig or sled to support the bamboo.

Saw Type & Blade Specification. Several models and sizes or radial arm saws were tested, with multiple blade sizes but most production has been done with a radial arm saw capable of taking a 305-mm diameter, 4 mm kerf, 20 tooth carbide tipped ripping blade. The saw needs to provide sufficient power and stability for ripping bamboo.

Dust Box/Blade Guard. The rationale for building a box around the saw is to keep hands far away from the blade and dust away from the operator, the dust box inlet and outlet should be big enough to not create any risk of waste bamboo pinching when it falls off because that could cause a dangerous ejection, but small enough to allow a high meter cube per hour dust extraction system to create sufficient suction. Soft flaps can be used at the opening to reduce the loss of suction at the opening while still allowing unencumbered movement of the sled mounted bamboo to move through the track and saw blade with ease.

Sled Specification & Features. The sled was made from 18 mm melamine coated particle board and 30 mm plywood. It fit a track in the saw with approximately a 0.5 mm gap. The table and track are also made from the same melamine which creates the side walls, and a layer of 6 mm plywood was used to create the capture. They were assembled with pocket hole screws. Throughout the development of this process many sled types were built and tested to hold the bamboo securely for ripping. The final method established a sled as shown in FIG. 18 a variety of features: (1) it is light, flat, and stiff; accomplished by using the vertical feature to brace the base of the sled, (2) fast and easy bamboo securement method (e.g., accomplished with 6 mm steel bolts and barrel nuts used to clamp the stock to the jig at each end), (3) the bamboo is elevated, allowing fall-off to drop well below the depth of the blade, reducing the risk of debris pinching and ejecting, (4) a middle fulcrum slightly cambers the bamboo, reducing unsupported span and resultant vibration.

Ripping. Ripping with a radial arm saw can be carried out in two distinct ways t: in-rip and out-rip. These refer to the orientation of the open face of the saw blade, meaning the blade is facing toward the saw column during in-rip and facing away from the column in out-rip. The distinction between these two ripping methods is that the blade rotates in a different direction for each, and therefore the material is fed into the saw from opposite ends. FIG. 18 shows an in-rip setup where the blade is rotating counter-clockwise. In this orientation, stock should be fed right to left (looking from the front of the saw) so that the blade is spinning up into the material. In woodworking terminology, this is considered conventional cutting. If the material was fed left to right in this scenario (power cutting), the cut would not be as clean and there is a higher risk of the material being pulled with the blade and ejected. For an out-rip, the opposite feed direction applies.

Using the RAS setup, dust enclosure, and work-holding jig shown in FIG. 18, the process of ripping the bamboo can be described. Once a pole is securely fastened to the jig, it can be inserted into the sled track without the saw operating (turned on). The bamboo pole can be used as a reference for setting the blade to the desired depth of rip, locking the saw in this position on the arm. Once this is complete, back the jig away from the blade and turn the saw on to begin ripping the bamboo.

Ripping is most efficiently completed with two operators: a feeder and a receiver. The feeder can push the jig into the saw until the front clamp is through the dust enclosure. At this point, the receiver can take over and pull the jig the rest of the way through. Once the receiver begins to pull, the feeder stops pushing. This way there is no added tension on the jig, and the feeder will not be pulled toward the saw if the receiver has a strong pull. As the receiver pulls the jig through, they should pin the bamboo fall-off to the pole, preventing it from twisting or getting caught up with any element of the system and being propelled by the blade. For safety, the operators should always stand on the side of the jig opposite of where the bamboo is being faced. In the case of an ejection, this avoids standing directly in line with the fall-off. Once the receiver takes over responsibility of moving the stock through the blade, the feeder should stand off to the side of the saw.

Once the first pass is completed, the receiver can hand the jig back to the feeder, the jig can be rotated 180 degrees, and fed back through for the second face. After both faces are ripped, the pole can be removed by loosening the bolts, and a new pole loaded for facing. Using these methods, ripping bamboo with a radial arm saw can be safe, fast, and efficient. Alternatively, if 3-4 laborers were involved in the process (2 saw operators and 1-2 loading/unloading jigs), this method can be more than twice as efficient. If poles are consistently being fed through the saw with minimal delay between each one, the processing rate can be two meters per minute, which can yield enough faced bamboo in an hour to construct a prototype-scale structure/product.

Digital Surfacing

Although a lot can be accomplished by manually modifying bamboo it also results in tradeoffs. For instance, the speed of the analog facing operations is quite high but so is the loss of biomass by comparison to only making local modifications such as pocket, slots or holes in the stock. Biomass loss or fall off can reach 15% if the bamboo is very irregular and in some cases the stock may be so irregular that facing is not a practical option at all. Furthermore, there are situations in which the quantity or complexity for specific geometry is too small or complex respectively to be applied via a manual operation. In some cases, it may be worth considering a more localized approach for modification. This is possible via Computer Numerical Controlled (CNC) milling. A variety of types of CNC machines can be used. These types of machines are commonly used to make customized parts from flat engineered wood panels but when outfitted with the proper work holding, indexing or additional axis of movement they can also be used for linear materials including round stock and boards made from soft materials such as wood and plastic.

It is also possible to CNC mill natural culm bamboo, but this needs custom work holding jigs to help manage the materials eccentricities of form and solidity. Methods to mill high solidity low linearity bamboo on a CNC milling machine, which can be used to make localized flatness for jointing and other geometries along an otherwise irregular length, will now be examined. Although there are many other opportunities for digital fabrication with bamboo, selective milling of regions for connections is presented.

Qualifying and Assigning. For bamboo to be digitally surfaced, it should be confirmed that there is material where it is needed to achieve the final part. The bamboo must contain usable geometry of the proper size and solidity. In order to determine this, sizing fixtures and/or templates can be used. It is important to confirm that there is sufficient outer diameter, centricity and linearity to allow the milled faces to fall within the solid portions of the natural shape of the bamboo element intended for the part.

The general confirmation can also include diameter, node distribution, and weight but may lack the detail of the actual bamboo morphological shape. Another approach can include taking a 3D scan to yield a precise digital twin of the actual bamboo element. Once a section of a bamboo culm is matched by general conformation, it can be marked for cutting and labeled with, e.g., a unique identifier so that a machining file can be associated with the intended stock. The stock will then be ready for cross cutting and indexing.

Indexing. The selected bamboo can be cut with parallel crosscut ends, using the same general methods as discussed with analog facing to establish a 2D theoretical centerline. The cut stock can receive the final position attribute by affixing a pair of registration pucks at the center of each end cut. The registration pucks can be affixed using adhesive, fasteners, or by other appropriate method. Once these are added, the bamboo is physically configured for machining, and the theoretical centerline for rotary CNC milling is made. Because these indexes need to be firmly but also quickly, accurately and durably affixed, they can be made from hardwood plywood and affixed by way of a two-step process of gluing and then adding 3 or 4, 23 gauge headless pin nails to each end of the bamboo part.

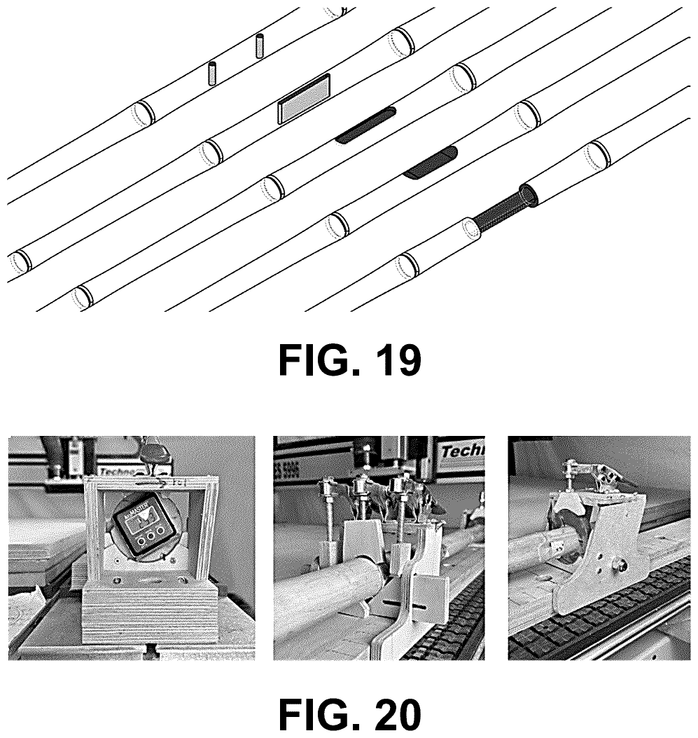

Geometries. Many features can be milled into a high solidity bamboo pole, such as through holes, slots, profiles and contours and pockets. In most cases this can be accomplished with a typical 3-axis (X, Y, Z) CNC with an added jig for 4th axis positioning. Twists and rotational surface features can be milled if the machine is equipped with a 4th A-axis. Stock stability and support are important factors to allow CNC milling of the bamboo. FIG. 19 illustrates examples of digital features that can be milled in or through the bamboo.

Positioning Strategies. Although establishing a theoretical centerline by adding the work holding pucks accommodates some machining there are limitations for how far the bamboo can span unsupported. Also, bamboo's organic shape also makes practical limitations for how to hold it mid span. On a 4-axis rotary machine, the lengths of Dendrocalamus strictus that can be machined may be limited to approximately 1.5 m because there is no easy way to support the middle of the organically shaped bamboo culm. However, on a 3-axis machining with a jig for 4th-axis positioning provides the opportunity to add interstitial supports making it possible to machine longer lengths of up to 3 m. In either case, the length of unsupported material should be limited as much as possible and in general terms the best results have been obtained at under one meter of unsupported spans.

4th Axis Positioning Jigs. The fourth axis position jig is made up of several assemblies, which can include: (a) base, (b) clamping head stock, (c) clamping bridge, and (d) clamping tail stock. FIG. 20 includes images of an example of a 4th axis positioning jig. Although the names are similar to those used on a lathe it is important to recognize that there is no powered rotational control but instead a manual method to set an A-axis position. The A-axis position can be set by manually spinning the clamping head stock in its saddle while indexing with a digital angle finding device, once an angle is set the angle is fixed in two or three places by adjusting the depth and tightening the clamping mechanisms. When a culm is long enough to need a bridge, it can be set in a different way because the center and shape of the bamboo is unknown in the middle of the length. In these locations a set of fixable wedges can be adjusted to lightly touch the lower surface of the bamboo, and then locked using an additional toggle clamp which can be adjusted in depth to add downward pressure locking the culm into place. The placement of these supports should not be in areas that will be milled.

4 Axis Milling Machine. Fourth axis milling is very effective at limited lengths, because it reduces the need for hand rotation and additional affixing via bridges. This makes for a faster and more reliable workflow. Fourth axis CNC mills are less common than 3 axis ones. In other embodiments, a rotary four axis CNC can be specifically made for bamboo. A dedicated machine prototype was built for this purpose. A machine that offers an A-axis can also be utilized.

Cutters. Multiple cutters have been examined, and it was found that large shank diameter tools provide the best results because they can handle the vibration caused by milling bamboo on a non-stable workpiece. For example, the following parameters have been used successfully. A step down of 6 mm per pass, with a plunge rate of 400 mm per minute, and a horizontal movement of 1200 mm per minute. All carbide milling tools for wood can be used for bamboo. However, tool life is shorter with bamboo than other woody materials due to the hard outer layer and its lack of stiffness. For most operations other than drilling two cutters have been used. For drilling no specific challenges were found to exist, and any diameter over 3 mm can generally be packed into a bamboo element.

Tool Path Strategy. Bamboo has a high probability of tearing out with some cutting geometries and therefore sometimes tool path direction can be important. The milling parameters can be specific to the condition of the bamboo, geometry cut, machine rigidity and available cutters and may vary as these conditions change.

Opportunities for tooling bamboo for design may be easily understood from an incremental innovation perspective as being situated between wood and steel design and fabrications, however they also suggest new architectural forms perhaps within some of the current vernacular architectural styles already emerging with bamboo. In these areas the consistency of faces that could be joined with repeatable composite assembly are promising. Also, in areas of freeform structures there is huge potential if we can both express bamboo's wildness and tame it to be reliable, more knowable and modestly accurate like many other building systems.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. A panel system, comprising:
a central core comprising a layer of substantially aligned bamboo poles;
a first outer lath layer comprising a first plurality of substantially aligned bamboo lathes or poles extending across a first side of the central core, the first plurality of substantially aligned bamboo lathes or poles positioned at least at a first angle with respect to the bamboo poles; and
a second outer lath layer comprising a second plurality of substantially aligned bamboo lathes or poles extending across a second side of the central core, the second plurality of substantially aligned bamboo lathes or poles positioned at least at a second angle with respect to the bamboo poles.

2. The panel system of claim 1, comprising a skin layer applied to an outer surface of at least one of the first or second outer lath layer, the outer surface opposite the central core.

3. The panel system of claim 2, wherein the skin layer comprises a woven layer.

4. The panel system of claim 1, wherein joints of the bamboo poles are staggered.

5. The panel system of claim 1, wherein individual bamboo poles of the central core extend continuously across the panel system.

6. The panel system of claim 5, wherein at least a portion of the individual bamboo poles comprise splice joints.

7. The panel system of claim 1, wherein the central core, first outer lath layer and the second outer lath layer are secured in a mycelium matrix.

8. The panel system of claim 1, wherein the central core comprises conduit extending through the layer of substantially aligned bamboo poles.

9. The panel system of claim 8, wherein the conduit is substantially perpendicular to the bamboo poles.

10. The panel system of claim 1, wherein the first angle and the second angle are the same.

11. The panel system of claim 1, wherein the first angle and the second angle are different.

12. The panel system of claim 11, wherein the first angle and the second angle are substantially perpendicular to each other.

13. The panel system of claim 1, wherein the first outer lath layer or the second outer lath layer is a woven structure comprising bamboo laths positioned at two angles.

14. A method, comprising:
forming a central core by aligning a plurality of bamboo poles;
forming a first outer lath layer by affixing a first plurality of substantially aligned bamboo lathes or poles across a first side of the central core, the first plurality of substantially aligned bamboo lathes or poles positioned at least at a first angle with respect to the bamboo poles;
forming a second outer lath layer by affixing a second plurality of substantially aligned bamboo lathes or poles across a first side of the central core, the second plurality of substantially aligned bamboo lathes or poles positioned at least at a second angle with respect to the bamboo poles.

15. The method of claim 14, wherein the first and second outer lath layers are affixed to the central core by adhesive, fasteners, or a combination of both.

16. The method of claim 14, comprising facing the plurality of bamboo poles to provide substantially planar surfaces on opposite sides of each bamboo pole that are substantially parallel to each other, wherein alignment of each of the plurality of bamboo poles positions the planar surfaces to provide the first and second sides of the central core with a substantially planar surface for attachment of the first and second outer lath layers.

17. The method of claim 16, wherein individual bamboo poles of the first or second outer lath layer comprise a substantially planar surface for attachment to the central core.

18. The method of claim 17, comprising facing the individual bamboo poles to provide the substantially planar surface.

19. The method of claim 14, wherein the first and second outer lath layers are affixed to the central core by adhesive, fasteners, or a combination of both.

20. The method of claim 14, wherein the plurality of bamboo poles of the central core comprise different wall thicknesses.
